(19) United States
(12) Patent Application Publication
(10) Pub. No.: US 2011/0309610 A1
(43) Pub. Date: Dec. 22, 2011

(54) WALL-MOUNTED BOLT ASSEMBLY

(76) Inventor: Chiu-Chih Chung, Kan Chen (TW)

(21) Appl. No.: 12/820,781

(22) Filed: Jun. 22, 2010

(51) Int. Cl. F16L 5/00

(52) U.S. Cl. 285/136.1

(57) ABSTRACT

A wall-mounted bolt assembly includes a bolt seat, a bolt pipe and a nut. The bolt seat has a central guide threaded trough. One end of the bolt seat is provided with a tray. The bolt pipe is a hollow pipe. The bolt pipe includes an outer threaded section at one end thereof and a stepped sleeve at another end thereof. The outer threaded section is connected to the bolt seat. The sleeve is integrally formed with the outer threaded section and connected with an engaging ring. The nut is hollow and has an inner threaded section. The engaging ring is disposed at one end of the nut to abut against the sleeve of the bolt pipe. Thereby, the engaging ring in the nut abuts against the sleeve of the bolt pipe. The bolt pipe is inserted through the nut. The outer threaded section is screwed to the guide threaded trough of the bolt seat and has a portion inserted in a water pipe. One end of the sleeve is exposed out of the nut. The tray is adapted to cover an outlet of the water pipe. One end of a faucet is connected to the nut.

### BACKGROUND OF THE INVENTION

1. Field of the Invention

The present invention relates to a wall-mounted bolt assembly, and more particularly to a bolt assembly having a bolt pipe which has an outer threaded section and a sleeve to connect with a guide threaded trough of a bolt seat and an engaging ring in a nut, respectively. The outer threaded section is further connected to a pipe. The present invention provides a simple installation and manufacture.

2. Description of the Prior Art

As shown in FIG. 1 and FIG. 2, a conventional wall-mounted bolt assembly comprises a dual-head threaded pipe 11, a nut 12, and a bolt 13. The threaded pipe 11 has an outer threaded section screwed to a water pipe A. The nut 12 is fitted on an inner threaded section of the threaded pipe 11. The bolt 13 and a washer S are located in the nut 12. The bolt 13 is screwed to the inner threaded section of the threaded pipe 11. One end of a faucet F is connected to the nut 12.

When screwing the bolt 13 to the inner threaded section, the bolt 13 is subject to the diameter of the nut 12. It is not easy to connect the bolt 13 and the threaded pipe 11 together. The bolt 13 may be omitted when in assembly and disassembly because it is a small part. This is not convenient and practical when in use.

It is complicated and difficult to manufacture the threaded pipe 11 because the threaded pipe 11 includes the outer threaded section, the inner threaded section at two ends and a central board.

### SUMMARY OF THE INVENTION

A wall-mounted bolt assembly includes a bolt seat, a bolt pipe and a nut. The bolt seat has a central guide threaded trough. One end of the bolt seat is provided with a tray. The bolt pipe is a hollow pipe. The bolt pipe includes an outer threaded section at one end thereof and a stepped sleeve at another end thereof. The outer threaded section is connected to the bolt seat. The sleeve is integrally formed with the outer threaded section and connected with an engaging ring. The nut is hollow and has an inner threaded section. The engaging ring is disposed at one end of the nut to abut against the sleeve of the bolt pipe. Thereby, the engaging ring in the nut abuts against the sleeve of the bolt pipe. The bolt pipe is inserted through the nut. The outer threaded section is screwed to the guide threaded trough of the bolt seat and has a portion inserted in a water pipe. One end of the sleeve is exposed out of the nut. The tray is adapted to cover an outlet of the pipe. One end of a faucet is connected to the nut. The present invention is simple for installation and convenient for use.

The sleeve is integrally formed with the outer threaded section of the bolt pipe and connected with the engaging ring. When in assembly or disassembly, they won't be omitted and restrained by other parts. They can be assembled in a quick way.

The bolt seat and the bolt pipe of the present invention are simple to manufacture, without a complicated procedure to mould.

### BRIEF DESCRIPTION OF THE DRAWINGS

FIG. 1 is an exploded view of a conventional wall-mounted bolt assembly;

FIG. 2 is a cross-sectional view of the conventional wall-mounted bolt assembly when in use;

FIG. 3 is an exploded view of a preferred embodiment of the present invention; and

FIG. 4 is a cross-sectional of the preferred embodiment of the present invention when in use.

### DETAILED DESCRIPTION OF THE PREFERRED EMBODIMENTS

Embodiments of the present invention will now be described, by way of example only, with reference to the accompanying drawings.

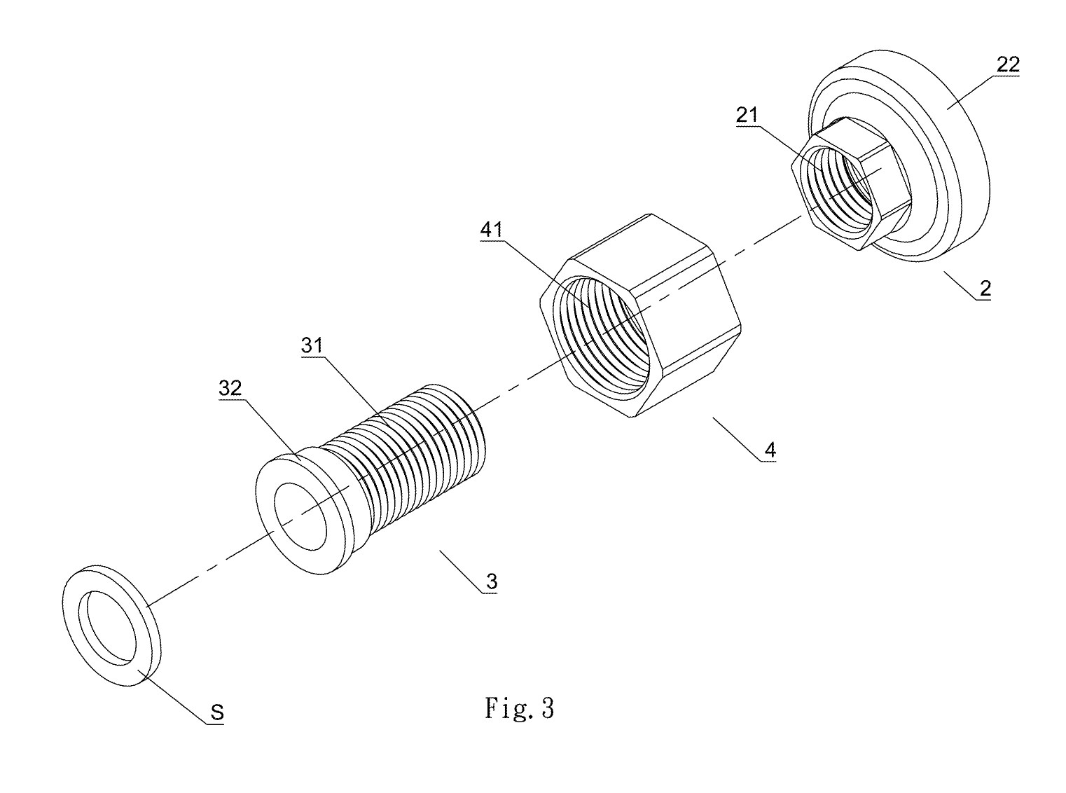

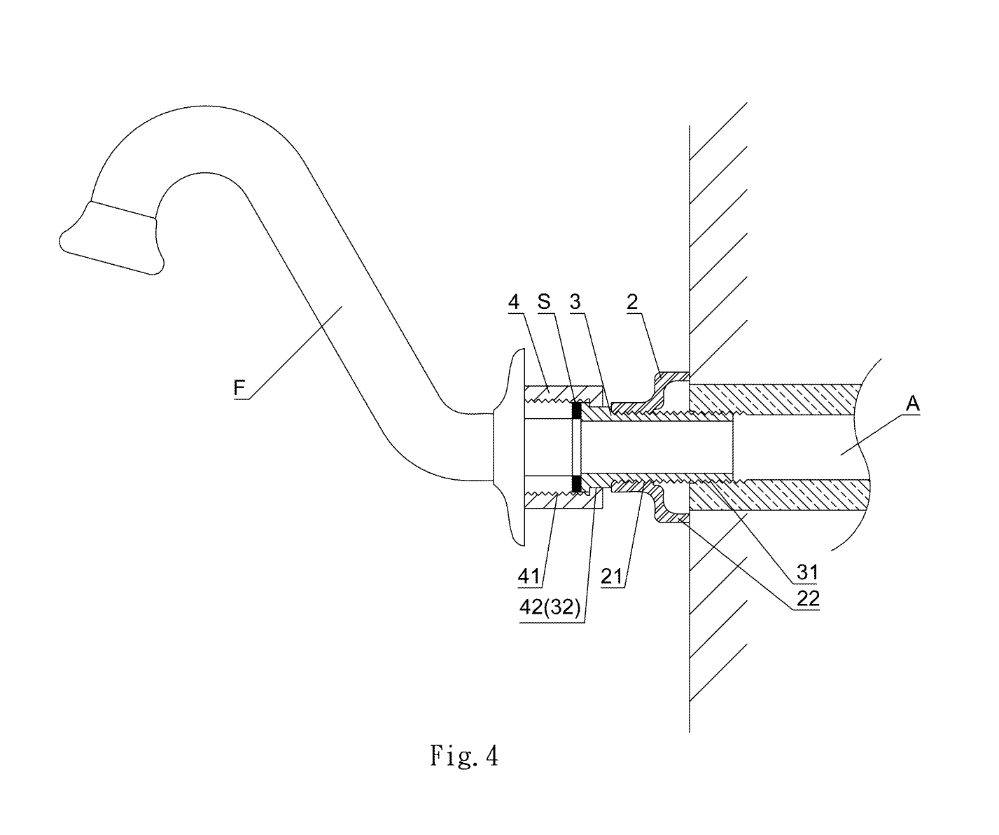

As shown in FIG. 3 and FIG. 4, a wall-mounted bolt assembly according to a preferred embodiment of the present invention comprises a bolt seat 2, a bolt pipe 3, and a nut 4.

The bolt seat 2 has a central guide threaded trough 21 for connection of the bolt pipe 3. One end of the bolt seat 2 is provided with a tray 22 attached to a wall to cover an outlet of a pipe.

The bolt pipe 3 is a hollow pipe. The bolt pipe 3 includes an outer threaded section 31 at one end thereof and a stepped sleeve 32 at another end thereof. The outer threaded section 31 is connected to the bolt seat 2. The sleeve 32 is integrally formed with the outer threaded section 31 and inserted in the nut 4 to restrain the bolt seat 2.

The nut 4 is hollow and has an inner threaded section 41. One end of the nut 4 is connected to a faucet F, and another end of the nut 4 is provided with an engaging ring S to abut against the sleeve 32 of the bolt pipe 3. The present invention is simple for installation and convenient for use.

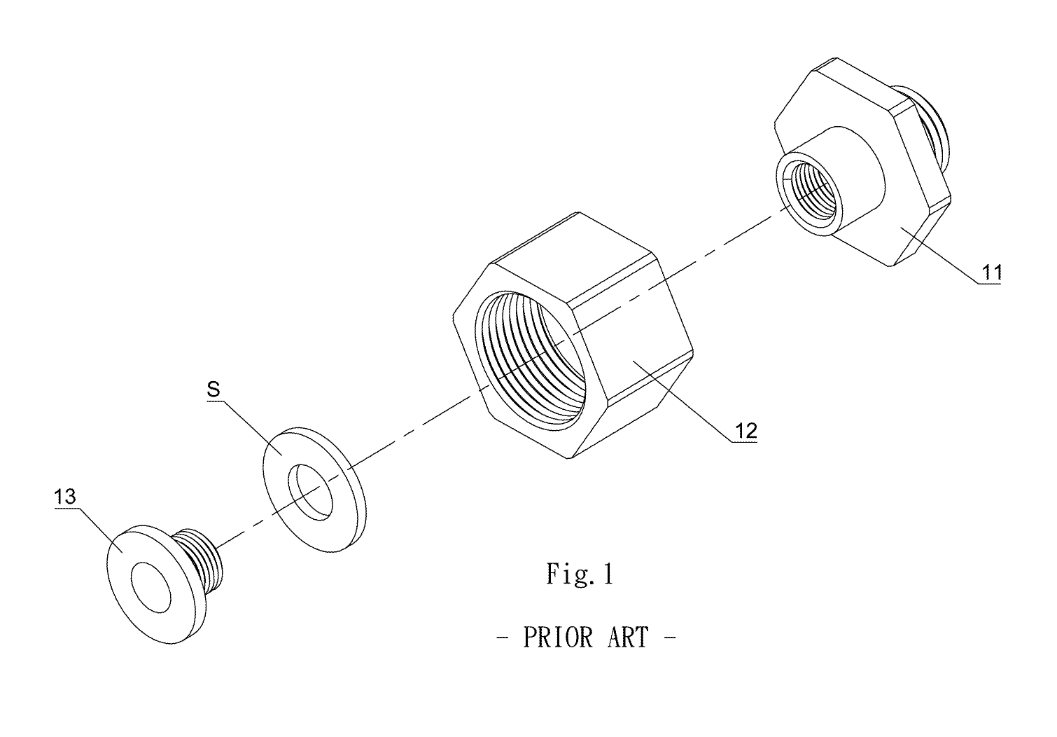

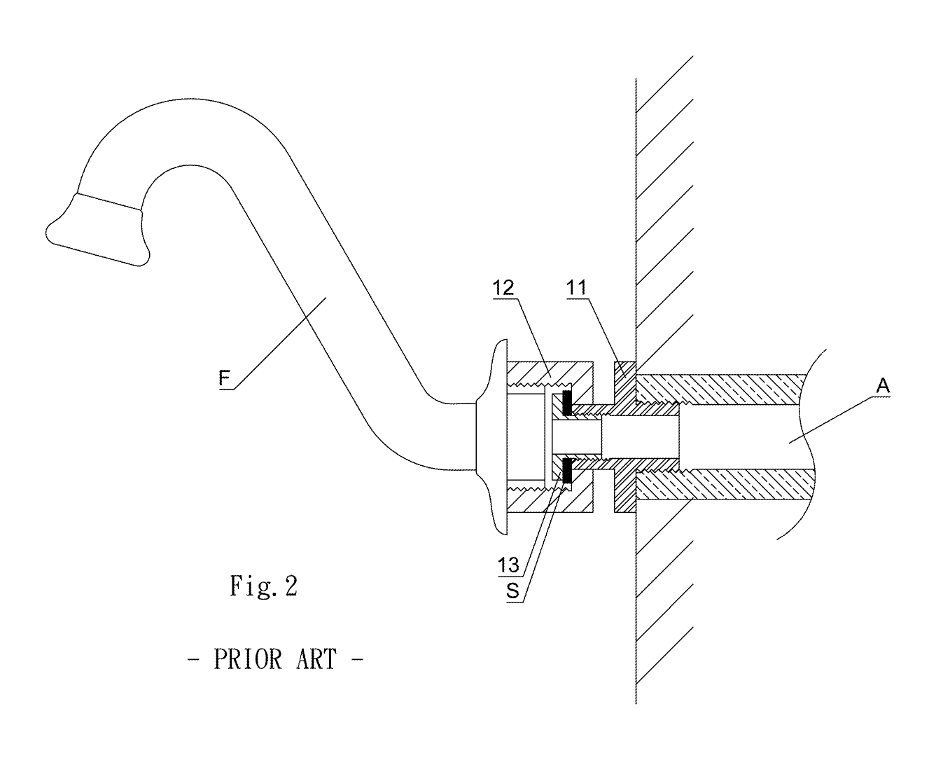

Referring to FIG. 1 and FIG. 2, the engaging ring S in the nut 4 abuts against the sleeve 32 of the bolt pipe 3. The bolt pipe 3 is inserted through the nut 4. The outer threaded section 31 is screwed to the guide threaded trough 21 of the bolt seat 2 and has a portion inserted in the water pipe A. One end of the sleeve 32 is exposed out of the nut 4. The tray 22 is adapted to cover the outlet of the water pipe A. The engaging ring S is disposed in the nut 4, and the nut 4 is screwed to the faucet F. The present invention provides a quick installation way.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A wall-mounted bolt assembly, comprising:
a bolt seat having a central guide threaded trough, one end of the bolt seat being provided with a tray;
a bolt pipe, the bolt pipe being a hollow pipe, the bolt pipe including an outer threaded section at one end thereof and a stepped sleeve at another end thereof, the outer threaded section being connected to the bolt seat, the sleeve being integrally formed with the outer threaded section and connected with an engaging ring; and
a nut, the nut being hollow and having an inner threaded section, the engaging ring being disposed at one end of the nut to abut against the sleeve of the bolt pipe;
thereby, the engaging ring in the nut abutting against the sleeve of the bolt pipe, the bolt pipe being inserted through the nut, the outer threaded section being screwed to the guide threaded trough of the bolt seat and having a portion inserted in a water pipe, one end of the sleeve being exposed out of the nut, the tray being adapted to cover an outlet of the water pipe, the nut being connected to a faucet.
